(19) United States
(12) Patent Application Publication
(10) Pub. No.: US 2018/0032500 A1
(43) Pub. Date: Feb. 1, 2018

(54) DEFLUFFING AND FLUFFING OF PHRASES DURING COMMUNICATION BETWEEN INDIVIDUALS

(71) Applicant: International Business Machines Corporation, Armonk, NY (US)

(72) Inventors: Lisa Seacat DeLuca, Baltimore, MD (US); Dana L. Price, Surf City, NC (US); Aaron J. Quirk, Cary, NC (US); Shelbee D. Smith-Eigenbrode, Thornton, CO (US)

(21) Appl. No.: 15/223,003

(22) Filed: Jul. 29, 2016

(51) Int. Cl. G06F 17/27; H04W 4/14; H04L 12/58

(52) U.S. Cl. CPC G06F 17/274; H04L 51/04; H04W 4/14; G06F 17/277

(57) ABSTRACT

Embodiments of the present invention provide a system and method for restyling written messages based on style preferences of the recipient. A sender composes a message to a recipient. The style preferences of the recipient are retrieved. The style of the sender's message is determined through computer-implemented linguistic analysis. The style of the original message composed by the sender is compared to the style preferred by the recipient. A computer-implemented process changes the original message to a restyled message for communicating to the recipient in a style that is preferred by the recipient.

### FIELD OF THE INVENTION

The present invention relates generally to electronic communication and, more particularly, to modification of written messages during communication between a sender and a recipient.

### BACKGROUND

Electronic written communication is prevalent in today's society. Email, instant messaging, social networking messages, and text messaging are common forms of electronic written communications. These systems may be used for both work and personal use. During the course of a day, a person may communicate with many other people by electronic written communication. Text messaging systems, such as the widely used Short Message Service (SMS), enable exchange of text messages between communication devices such as smartphones. Email is typically used on computers as well as mobile devices such as tablets and smartphones. The advent of smartphones and tablets makes electronic written communication convenient. Thus, it is desirable to have improvements in electronic written communication.

### SUMMARY

Embodiments of the present invention provide a system and method for restyling written messages based on style preferences of the recipient. A sender composes a message to a recipient. The style preferences of the recipient are retrieved. The style of the sender's message is determined through computer-implemented linguistic analysis. The style of the original message composed by the sender is compared to the style preferred by the recipient. A computer-implemented process changes the original message to a restyled message for communicating to the recipient in a style that is preferred by the recipient.

In one embodiment, there is provided a computer-implemented method, comprising: obtaining a message from a sender; identifying a recipient for the message; determining an original style for the message; determining a target style for the recipient; restyling the message to a restyled message in the target style if the original style and target style differ; and sending the restyled message to the recipient.

In another embodiment, there is provided a device comprising: a processor; a memory coupled to the processor; wherein the memory contains instructions, which when executed by the processor, perform the steps of: obtaining a message from a sender; identifying a recipient for the message; determining an original style for the message; determining a target style for the recipient; restyling the message to a restyled message in the target style if the original style and target style differ; and sending the restyled message to the recipient.

In yet another embodiment, there is provided a computer program product for controlling modification of written messages during communication on an electronic device, comprising a computer readable storage medium having program instructions embodied therewith, the program instructions executable by a processor to cause the electronic device to: obtain a message from a sender; identify a recipient for the message; determine an original style for the message; determine a target style for the recipient; restyle the message to a restyled message in the target style if the original style and target style differ; and send the restyled message to the recipient.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is a block diagram of a device in accordance with embodiments of the present invention.

FIG. 2 is a block diagram of software modules within an application in accordance with embodiments of the present invention.

FIG. 3 is a system diagram in accordance with embodiments of the present invention.

FIG. 4 is a diagram illustrating an embodiment of the present invention.

FIG. 5 is a diagram illustrating another embodiment of the present invention.

FIG. 6A and FIG. 6B show examples of message restyling.

FIG. 7 is a flowchart indicating process steps for embodiments of the present invention.

FIG. 8 is a diagram illustrating another embodiment of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Embodiments of the present invention provide a system and method for restyling written messages based on style preferences of the recipient. A sender composes a message to a recipient. The style preferences of the recipient are retrieved. The style of the sender's message is determined through computer-implemented linguistic analysis. The style of the original message composed by the sender is compared to the style preferred by the recipient. A computer-implemented process changes the original message to a restyled message for communicating to the recipient in a style that is preferred by the recipient.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

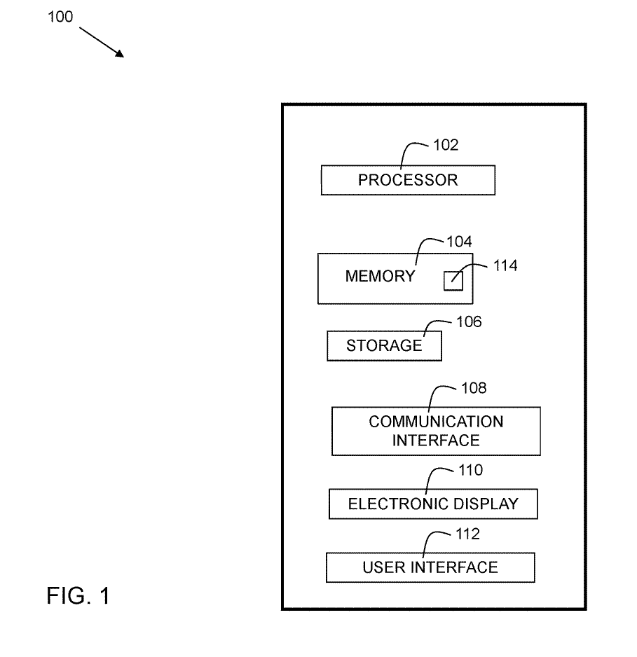

FIG. 1 is a block diagram of an electronic device 100 in accordance with embodiments of the present invention. Device 100 includes a processor 102. The processor 102 may include one or more processing cores. Device 100 further includes memory 104. The memory 104 is coupled to the processor such that instructions stored in memory 104 can be executed by the processor 102 to implement aspects of disclosed embodiments. The memory 104 may include dynamic random access memory (DRAM), static random access memory (SRAM), magnetic storage, and/or a read only memory such as flash, EEPROM, optical storage, or other suitable memory. In some embodiments, the memory 104 may not be a transitory signal per se. Device 100 may further include additional storage 106. Additional storage 106 may include, but is not limited to, solid state storage such as SRAM, Flash, and/or magnetic or optical storage. Device 100 further includes a communication interface 108. The communication interface 108 may support a variety of protocols, including, but not limited to, WiFi, Bluetooth™, Ethernet, TCP/IP, UDP, and/or other protocols and/or standards for communication. Device 100 further includes an electronic display 110. The electronic display may include a liquid crystal display (LCD), a plasma display, a cathode ray tube (CRT) display, a light emitting diode (LED) display, an organic LED (OLED) display, or other suitable display technology. Device 100 further includes a user interface 112. The user interface may include a keyboard, mouse, trackball, and/or touch screen, and provide a mechanism for a user to enter text into an application such as an email program, text messaging program, and/or web browser. In some embodiments, device 100 may include more or fewer features where feasible.

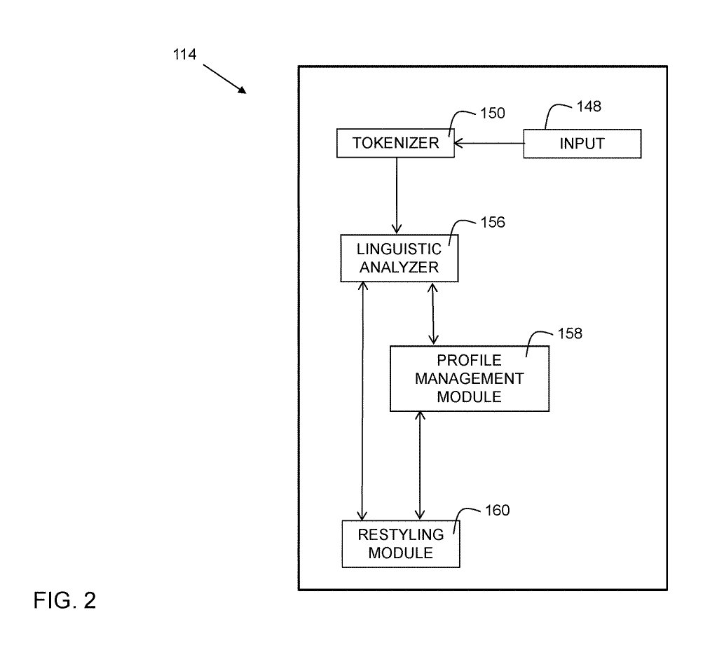

Referring again to memory 104, an application 114 may reside in memory 104. The application 114 may comprise one or more modules configured to perform tasks and/or steps for carrying out embodiments of the present invention. In some embodiments, the modules may be software. Additional details of the application 114 are shown in FIG. 2.

FIG. 2 is a block diagram of modules within an application 114 in accordance with embodiments of the present invention. Application 114 may include an input module 148. The input module 148 may obtain an original message from a sender. The original message obtained by input module 148 may then be processed by subsequent modules to produce a restyled message.

Application 114 may include a tokenizer 150. The tokenizer 150 converts a stream of text into words, phrases, symbols, or other meaningful elements called tokens. The tokens may be input into a list. The list of tokens then becomes input for further processing by the other software modules within the application 114.

Application 114 may include a linguistic analyzer 156. The linguistic analyzer 156 may process the tokens and interpret the meanings of each token. For example, consider the phrase: “He climbed the hill.” The linguistic analyzer 156 may attempt to identify the part of speech for each token. In this example, the linguistic analyzer 156 may associate each token with a part of speech, such that “he” is classified as a pronoun, “climbed” is classified as a verb, “the” is classified as an article, and “hill” is classified as a noun. The linguistic analyzer may check for proper spelling, punctuation, and grammar. Additionally, the linguistic analyzer may identify a style of writing based on how closely or distant the writing is to proper grammar.

Additionally, the linguistic analyzer may perform phoneme analysis, such that the sounds generated by misspelled words can be ascertained, and the intended meaning may be inferred. The phonemes may include groups of letters, single letters, and “leet” which is a combination of numbers and/or numbers and letters together to make words. As an example, the sentence “Did you see the formula?” can be written in leet as “Did u c the 4mula?” In addition to the phonetic properties of numbers, some leet substitutions may be based on the appearance of the number, and its resemblance to a letter. For example, the number 4 may be substituted for a capital “A” and the number 5 may be substituted for a capital “S.” Using these substitutions, the word “BEAST” becomes “BE45T.” Although this style of writing is not grammatically correct, many people communicate using a style that deviates at least somewhat from Standard English grammar. A variety of linguistic analyzers are available today, including Open Source linguistic analyzers such as grammark and LanguageTool. Additionally, the linguistic analyzer 156 may be implemented via a commercially available tool/service such as Watson's Personality Insights, Alchemy API Sentiment Analysis and/or Tone Analyzer services. In embodiments, the linguistic analyzer 156 is used to analyze messages composed by a sender, and may also be used in some embodiments for analyzing writing samples of recipients.

Application 114 may include a profile management module 158. The profile management module 158 may be configured to receive analysis results from the linguistic analyzer 156. The profile management module 158 may direct writing samples from known recipients to the linguistic analyzer 156 to classify a style of a writing sample. The classification of the writing style along with an identifier such as an email address, telephone number, and/or other user identifier may be stored by the profile management module. When a sender composes a message and identifies an intended recipient, the profile management module 158 can retrieve a style preference for that recipient. The style preference for a recipient is referred to as a target style. In embodiments, determining a target style for the recipient includes performing a linguistic analysis of previous communication from the recipient.

Application 114 may include a restyling module 160. The restyling module 160 may be used to alter an original message composed by a sender to create a restyled message in the target style of the recipient. Thus, the restyled message is a modification of the original message. The restyling module 160 may perform various operations, including, but not limited to, acronym expansion, acronym creation, adding capitalization, removing of capitalization, word count expansion, leet removal, and/or leet creation.

Thus, in embodiments, the application 114 may perform the functions of obtaining a message from a sender, identifying a recipient for the message, determining an original style for the message, determining a target style for the recipient, restyling the message from the original style to the target style if the original style and target style differ, and sending the restyled message to the recipient.

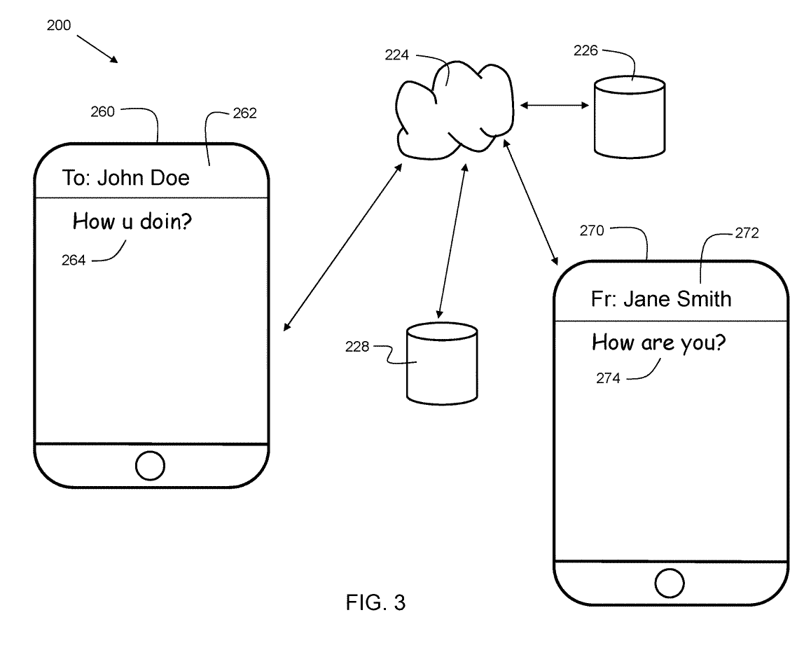

FIG. 3 is a system diagram 200 in accordance with embodiments of the present invention. A sender electronic device 260 is sending a message to a recipient electronic device 270 via network 224. In embodiments, network 224 may include a cellular network, WiFi network, Ethernet network, and/or the Internet. In embodiments, the electronic device may be a smart phone, tablet computer, desktop computer, or other device.

Sender device 260 displays a recipient “John Doe” in recipient field 262. Sender device 260 displays an original message “How u doin?” in original message field 264. The recipient device 270 displays a sender “Jane Smith” in sender field 272, and a restyled message “How are you?” in recipient message field 274. When the sender specifies a recipient for a message (e.g., John Doe), embodiments determine a target style for the recipient based on information such as previous communication, the amount of communication, the frequency of communication, and/or the duration of the communication. In some embodiments, the application 114 (FIG. 2) may obtain public communication written by the recipient from public websites 226 and/or 228. The public websites 226 and 228 may be social media sites, blog sites, or other websites where public communication written by the recipient can be obtained. For example, social media posts from the recipient's profile page can be analyzed to ascertain a target style.

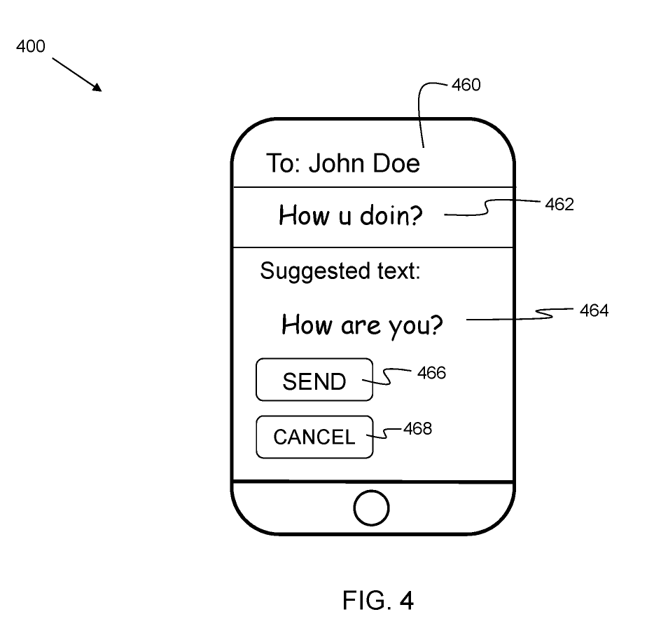

FIG. 4 is a diagram 400 illustrating an embodiment of the present invention, indicating suggested text. In this embodiment, the sender indicates a recipient in field 460, and composes an original message in field 462. The application determines a target style for the recipient, and provides a restyled message in field 464. The application provides a send button 466. The user can press the send button 466 if they wish to send the restyled message. If they do not wish to send the restyled message, the user can press the cancel button 468. The cancel button 468 prevents the restyled message from being sent. In embodiments, the application may send the original message in response to the user pressing the cancel button 468. Thus, this embodiment includes prompting the sender prior to sending the restyled message.

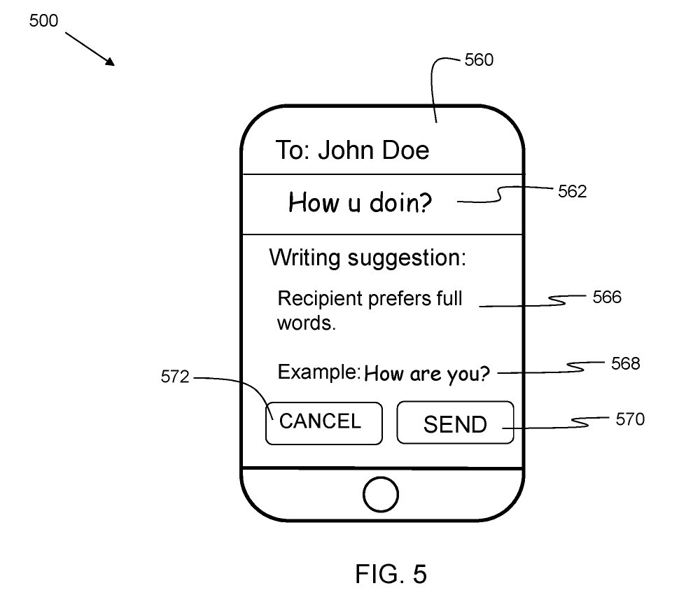

FIG. 5 is a diagram 500 illustrating another embodiment of the present invention, indicating a style recommendation. In this embodiment, the sender indicates a recipient in field 560, and composes an original message in field 562. The application determines a target style for the recipient, and provides a style recommendation 566 along with a restyled message in field 568. The application provides a send button 570. The user can press the send button 570 if they wish to send the restyled message. If they do not wish to send the restyled message, the user can press the cancel button 572. The cancel button 572 prevents the restyled message from being sent. In embodiments, the application may send the original message in response to the user pressing the cancel button 572. The style recommendation 566 provides an indication of written communication preferences of the recipient. Thus, this embodiment includes presenting the sender with a style recommendation (suggestion) for the recipient. The sender can then use this information to write messages in a style that the recipient prefers.

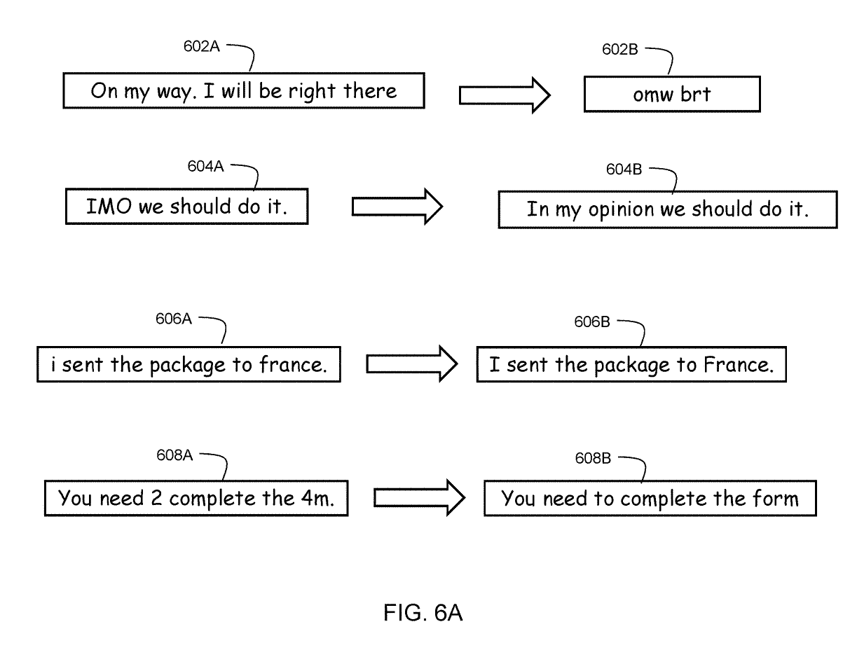

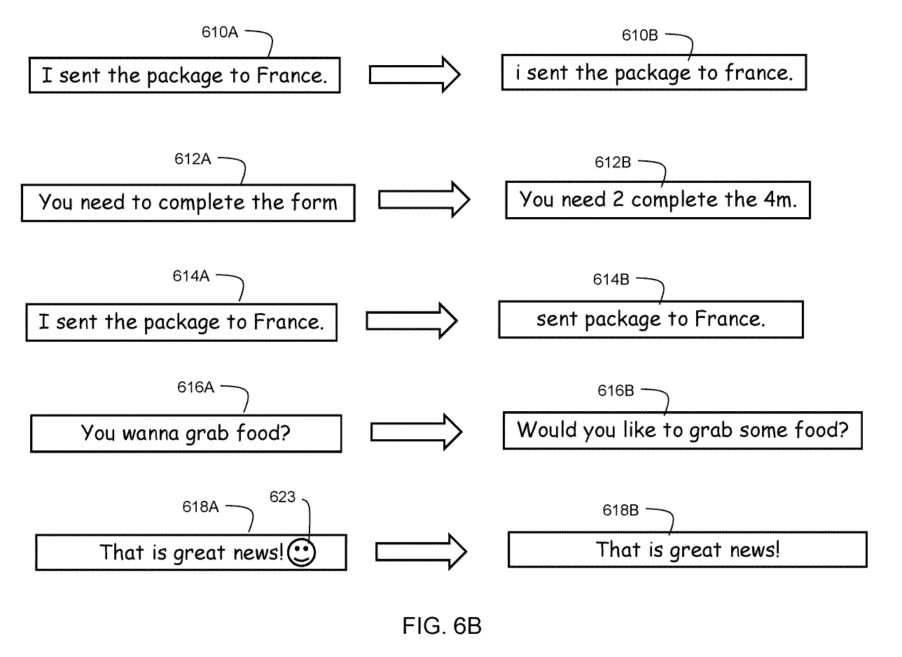

FIG. 6A and FIG. 6B show examples of message restyling. In FIG. 6A and FIG. 6B, references ending with an “A” are original messages and references ending with a “B” are restyled messages. Original message 602A is converted to restyled message 602B. In this example, the message is restyled to a less formal style. In this case, the restyling includes acronym creation. The phrase “On my way” in the original message 602A is converted to the acronym “omw” in the restyled message 602B. The phrase “I will be right there” is converted to the acronym “brt” in the restyled message 602B. Thus, the restyled message includes acronym creation and word count reduction.

Original message 604A is converted to restyled message 604B. In this example, the message is restyled to a more formal style. In this case, the restyling includes acronym expansion. The acronym “IMO” in the original message 604A is converted to the phrase “In my opinion” in the restyled message 604B. The restyled phrase contains seven words, whereas the original message 604A contains five words. Thus, the restyled message includes acronym expansion and word count expansion. In embodiments, an acronym table may be used to associate an acronym such as “IMO” with a phrase such as “In my opinion.” The acronym table may be stored in memory 104 and/or storage 106 of device 100 of FIG. 1. In embodiments, a user may enter new acronyms and a corresponding phrase to allow the system to process new words and acronyms as language evolves.

Original message 606A is converted to restyled message 606B. In this example, the message is restyled to a more formal style. In this case, the restyling includes adding capitalization. The phrase “i sent the package to france” in the original message 606A is converted to the phrase “I sent the package to France” in the restyled message 606B. The restyled phrase capitalizes the word “I” and the word “France.” Thus, the restyled message includes adding capitalization.

Original message 608A is converted to restyled message 608B. In this example, the message is restyled to a more formal style. In this case, the restyling includes leet removal. The number “2” in the original message 608A is converted to the word “to” in the restyled message 606B. The token “4m” in the original message 608A is converted to the word “form” in the restyled message 608B. Thus, the restyled message includes leet removal.

Referring now to FIG. 6B, original message 610A is converted to restyled message 610B. In this example, the message is restyled to a less formal style. In this case, the restyling includes removing capitalization. The phrase “I sent the package to France” in the original message 610A is converted to the phrase “i sent the package to france” in the restyled message 610B. The restyled phrase capitalizes the word “I” and the word “France.” Thus, the restyled message includes removing capitalization.

Original message 612A is converted to restyled message 612B. In this example, the message is restyled to a less formal style. In this case, the restyling includes leet creation. The word “to” in the original message 612A is converted to the number “2” in the restyled message 612B. The word “form” in the original message 612A is converted to the token “4m” in the restyled message 612B. Thus, the restyled message includes leet creation.

Original message 614A is converted to restyled message 614B. In this example, the message is restyled to a less formal style. In this case, the restyling includes word count reduction. The phrase “I sent the package to France” in the original message 614A is converted to the phrase “sent package to France” in the restyled message 614B. The pronouns and articles have been removed in the restyled message 614B to make it terser. The word count in the original message 614A is six words, and the word count in the restyled message 6146 is four words. Thus, the restyled message includes word count reduction.

Original message 616A is converted to restyled message 616B. In this example, the message is restyled to a more formal style. In this case, the restyling includes word count expansion. The phrase “wanna grab food?” in the original message 614A is converted to the phrase “Would you like to grab some food” in the restyled message 614B. The slang term “wanna” is interpreted as “Want to” and then converted to a more polite form as “Would you like to” and the subject is inferred as “you” based on the fact that the original message started the sentence with “You.” The word count in the original message 616A is four words, and the word count in the restyled message 6166 is seven words. Thus, the restyled message includes word count expansion.

Original message 618A is converted to restyled message 618B. In this example, the message is restyled to a more formal style. In this case, the restyling includes emoji removal. The emoji 623 in the original message 618A is removed in the restyled message 618B. Thus, the restyled message includes emoji removal.

Message styles such as those shown in 602B, 604A, 606A, 608A, 610B, 612B, 614B, 616A, and 618A may be considered as casual styles, as they contain non-standard spellings and/or non-standard punctuation. Message styles such as those shown in 604B, 606B, 608B, 610A, 612A, 614A, 616B, and 618B may be considered as formal styles.

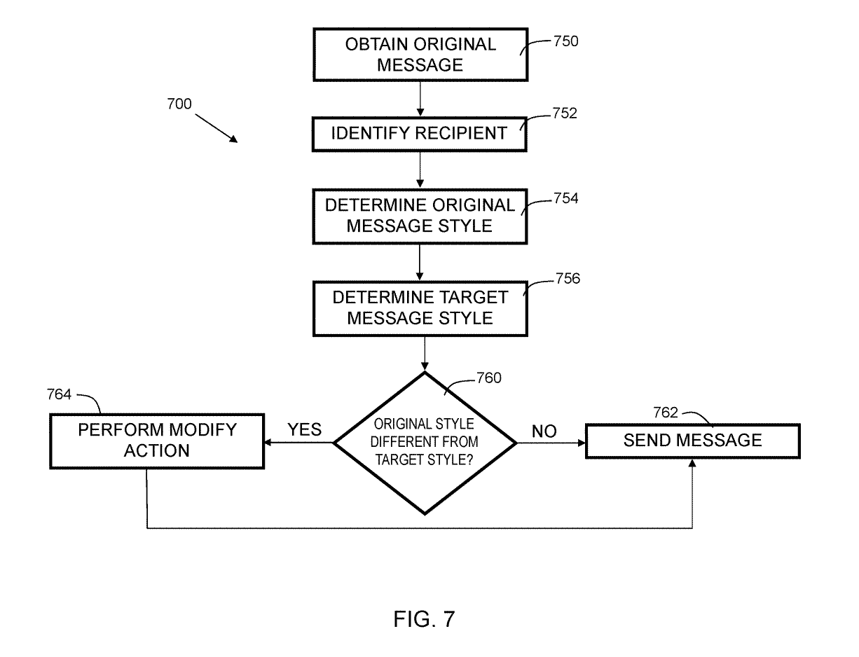

FIG. 7 is a flowchart 700 indicating process steps for embodiments of the present invention. In process step 750, an original message is obtained. The original message is the message as written by the sender. In process step 752, a recipient for the message is identified. For example, the recipient may be specified in the “To:” field of an email program, instant messaging program, or a text messaging program. In process step 754, a style for the original message is determined. In embodiments, the determining of the original message style is performed by the linguistic analyzer (156 of FIG. 2). In process step 756, a target style for the recipient is determined. The target style is the style that the recipient prefers, as determined by writing samples and possibly other criteria. In embodiments, the profile management module (158 of FIG. 2) retrieves a stored target style for a given recipient. The stored target style may be stored in the memory 104 and/or storage 106 of the device 100 of FIG. 1. In process step 760, a comparison is made to see if the original style is different from the target style. If no, then the message is sent in process step 762. If yes, then a modify action is performed in process step 764. The modify action may include, but is not limited to, providing a restyled message and prompting the sender if she wishes to send it (see FIG. 4), providing a writing style suggestion (see 566 of FIG. 5), or simply sending the restyled message without prompting. In embodiments, after a predetermined number of prompted messages that are sent, restyled messages are then automatically sent without prompting. For example, in an embodiment, after ten consecutive restyled messages are sent, the system may no longer prompt the user, and simply send the restyled message. This feature allows smooth communication flow once a level of confidence is reached in the restyling process. The order of steps shown in flowchart 700 is exemplary, and not intended to be limiting. In some embodiments, one or more process steps may be performed concurrently, or in a different order than as shown in flowchart 700.

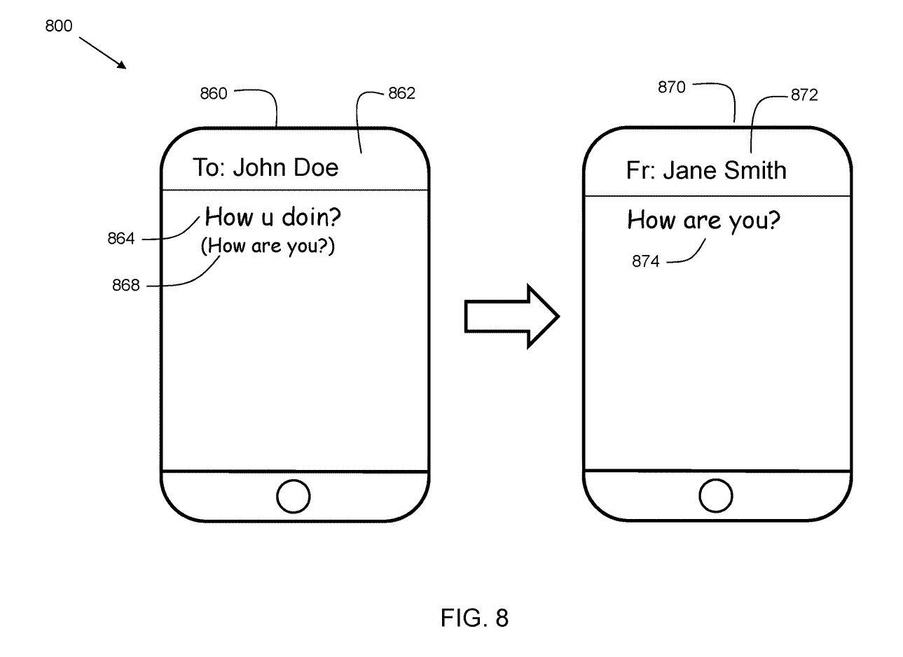

FIG. 8 is a diagram 800 illustrating an embodiment of the present invention, utilizing automatic sending of restyled messages. In this embodiment, the sender uses sender electronic device 860, indicates a recipient in field 862, and composes an original message 864. The application determines a target style for the recipient, and automatically sends a restyled message 868 to the recipient electronic device 870 in place of the original message. The sender can then see her original message 864, with the restyled message 868 shown in parentheses below it. In embodiments, other indicators such as different colors and/or fonts can be used to differentiate the original messages from the restyled messages. The recipient using device 870 only sees the restyled message 874 and does not receive the original message 864. The recipient device 870 displays a sender “Jane Smith” in sender field 872. If the recipient device is enabled with an embodiment of the present invention, the recipient device may perform a similar analysis on the user indicated in field 872, so that the user of device 870 can send appropriately styled messages back to the user of device 860.

While the examples disclosed herein utilize English, embodiments may also utilize other languages, including, but not limited to, French, Spanish, German, Italian, Russian, Chinese, Japanese, Korean, and Dutch. In some embodiments, emoji may be added or removed as part of the message restyling process. For example, if a recipient does not use emoji, then emoji may be stripped from the original message in order to create the restyled message. In some embodiments, a variety of metrics and/or statistics may be used to ascertain a message style. The metrics may include, but are not limited to, word count, average word length, rare words, average word length, average phrase length, average sentence length, lexical density, Gunning fog index, and/or count of unique words.

An additional factor used in determining a target style may include determining an age range for the recipient. For example, age range information may be entered into the application by a user, or retrieved from public profile information from a social medial website. In some embodiments, a higher age range may be used to infer a more formal style. For example, a person in the age range of 50 to 70 years of age may default to a more formal target style than a teenager. Another factor used in determining a target style may include determining a duration of contact time for the recipient. For example, the date of first communication with a recipient may be recorded. Then, the application can determine how long the sender and recipient have “known each other” regarding the messaging. The duration of time between the current time and the time of first contact is referred to as a contact time. In some embodiments, a longer duration of contact time may be used to infer a more casual style. Thus, as the sender and recipient know each other for a longer time period, the target style can gradually become more casual. For example, when the sender and recipient have a contact time of less than a week, the target style may be formal. When the sender and recipient have a contact time of over one year, the target style may be more casual. Another factor used in determining a target style may include determining a frequency of contact for the recipient. For example, the date and time of each communication with a recipient may be recorded. Then, the application can determine how often the sender and recipient exchange messages. In some embodiments, a higher contact frequency may be used to infer a more casual style. Thus, when a sender and recipient communicate often, the target style can become more casual. For example, when the sender and recipient communicate several times daily, the target style may be casual. When the sender and recipient communicate a few times during one year, the target style may be more formal. Embodiments of the present invention may be utilized in applications including, but not limited to, email, text messaging, and instant messaging. As can now be appreciated, disclosed embodiments provide improvements in electronic written communication.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

Embodiments of the invention may include a method that performs the process of the invention on a subscription, advertising, and/or fee basis. That is, a service provider, such as a Solution Integrator, could offer to provide deployment pattern cost analysis functionality. In this case, the service provider can create, maintain, support, etc., a computer infrastructure, such as device 100 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

Embodiments of the present invention may also include a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method, comprising:
obtaining a message from a sender;
identifying a recipient for the message;
determining an original style for the message;
determining a target style for the recipient;
restyling the message to a restyled message in the target style if the original style and target style differ; and
sending the restyled message to the recipient.

2. The method of claim 1, further comprising prompting the sender prior to sending the restyled message.

3. The method of claim 1, further comprising presenting the sender with a style recommendation for the recipient, prior to sending the restyled message.

4. The method of claim 1, wherein determining a target style for the recipient includes determining an age range for the recipient.

5. The method of claim 1, wherein determining a target style for the recipient includes determining a duration of contact time for the recipient.

6. The method of claim 1, wherein determining a target style for the recipient includes determining a frequency of contact for the recipient.

7. The method of claim 1, wherein determining a target style for the recipient includes performing a linguistic analysis of previous communication from the recipient.

8. The method of claim 7, wherein the previous communication is between the sender and the recipient.

9. The method of claim 7, wherein the previous communication is public communication from the recipient.

10. The method of claim 1, wherein the restyling includes acronym expansion.

11. The method of claim 1, wherein the restyling includes acronym creation.

12. The method of claim 1, wherein the restyling includes adding capitalization.

13. The method of claim 1, wherein the restyling includes removing capitalization.

14. The method of claim 1, wherein the restyling includes word count reduction.

15. The method of claim 1, wherein the restyling includes word count expansion.

16. The method of claim 1, wherein the restyling includes leet removal.

17. The method of claim 1, wherein the restyling includes leet creation.

18. The method of claim 1, wherein the restyling includes emoji removal.

19. A device comprising:
a processor;
a memory coupled to the processor;
wherein the memory contains instructions, which when executed by the processor, perform the steps of:
obtaining a message from a sender;
identifying a recipient for the message;
determining an original style for the message;
determining a target style for the recipient;
restyling the message to a restyled message in the target style if the original style and target style differ; and
sending the restyled message to the recipient.

20. A computer program product for controlling modification of written messages during communication on an electronic device, comprising a computer readable storage medium having program instructions embodied therewith, the program instructions executable by a processor to cause the electronic device to:
obtain a message from a sender;
identify a recipient for the message;
determine an original style for the message;
determine a target style for the recipient;
restyle the message to a restyled message in the target style if the original style and target style differ; and
send the restyled message to the recipient.
